(19) United States
(12) Patent Application Publication
(10) Pub. No.: US 2023/0066746 A1
(43) Pub. Date: Mar. 2, 2023

(54) THERMAL INTERFACE MATERIAL COMPRISING MAGNESIUM HYDROXIDE

(71) Applicant: DDP Specialty Electronic Materials US, LLC, Wilmington, DE (US)

(72) Inventor: YIQING HU, Shanghai (CN)

(21) Appl. No.: 17/796,325

(22) PCT Filed: Mar. 13, 2020
(86) PCT No.: PCT/CN2020/079110

§ 371 Date: Jul. 29, 2022

(51) Int. Cl. H01M 10/653; H01M 10/613; H01M 10/625; C09K 5/14; C08K 7/18

(52) U.S. Cl. CPC H01M 10/653; C08K 7/18; C09K 5/14; H01M 10/613; H01M 10/625; C08K 2201/001; C08K 2201/005; C08K 2201/014; H01M 2220/20

(57) ABSTRACT

A thermal interface material (TIM) composition comprising a polymeric binder component and about 50-90 wt% of spherical magnesium hydroxide particles having a particle size distribution D50 ranging from about 20-100 µm, with the total weight of the composition totaling to 100 wt%.

### FIELD OF DISCLOSURE

The disclosure relates to thermal interface materials and their use in battery powered vehicles.

### BACKGROUND

Compared to traditional modes of travel, battery powered vehicles offer significant advantages, such as light weight, reduced CO₂ emission, etc. However, to ensure optimal use of the technology, a number of technological problems still need to be overcome. For example, one current effort in the industry is to increase the driving range of battery powered vehicles by developing batteries with higher energy density. And this leads to the need to develop better thermal management systems for high energy density batteries.

In battery powered vehicles, battery cells or modules are thermally connected to cooling units by thermal interface materials (TIM). Such TIM are typically formed of polymeric materials filled with thermally conductive fillers. To achieve a thermal conductivity of 2 W/m·K or higher, fillers with thermal conductivity of 100 W/m·K or higher, such as boron nitrides or aluminum oxide, may be used. However, such fillers are expensive or abrasive to the adhesive pumping system. A cheaper and non-abrasive alternative is aluminum trihydroxide (ATH). Due to its lower thermal conductivity, however, high loadings of ATH (i.e., 80 wt% or higher) are needed. Such high loading of ATH, on the other hand, often leads to high viscosity and thus causes high thermal impedance. Moreover, due to high amount of residue water on the surface of ATH, it is not suitable for polyurethane based TIM. Thus, there is still a need to develop TIM with high thermal conductivity and low viscosity.

### SUMMARY

Provided herein are thermal interface materials (TIM) composition comprising: a) a polymeric binder component, and b) about 50-90 wt% of spherical magnesium hydroxide particles having a particle size distribution D₅₀ ranging from about 20-100 µm, with the total weight of the composition totaling to 100 wt%.

In one embodiment of the thermal interface material, the spherical magnesium hydroxide particles have an oil absorption value of about 1-30 ml/100 g.

In a further embodiment of the thermal interface material, the polymeric binder component is present at a level of about 10-50 wt%, based on the total weight of the composition.

In a yet further embodiment of the thermal interface material, the polymeric binder component is formed of polyurethane based material.

In a yet further embodiment of the thermal interface material, the spherical magnesium hydroxide particles have a particle size distribution D₅₀ ranging from about 25-60 µm.

In a yet further embodiment of the thermal interface material, the spherical magnesium hydroxide particles have a particle size distribution D₅₀ ranging from about 30-50 µm.

In a yet further embodiment of the thermal interface material, the thermal interface material further comprises about 2-50 wt% of spherical aluminum oxide particles.

In a yet further embodiment of the thermal interface material, the spherical aluminum oxide particles have a particle size distribution D₅₀ ranging from about 5-100 µm.

Further provided herein are articles comprising the thermal interface material composition provided above.

In one embodiment of the article, the article further comprises a battery module that is formed of one or more battery cells and a cooling unit, wherein, the battery module is connected to the cooling unit via the thermal interface material composition.

### DETAILED DESCRIPTION

Disclosed herein are thermal interface materials (TIM) comprising: a) a polymeric binder component and b) about 50-90 wt% of spherical magnesium hydroxide particles, with the total weight of the composition totaling to 100 wt%.

The polymeric binder component may be formed of any suitable polymeric material, which include, without limitation, binder material based on polyurethane, epoxy, silicone, modified silicone, acrylate, and etc. In one embodiment, the polymeric binder component is formed of a two-component polyurethane based binder material.

In accordance with the present disclosure, the polymeric binder component may be present in the TIM at a level of about 5-50 wt%, or about 10-40 wt%, or about 10-30 wt%, based on the total weight of the TIM composition.

The magnesium hydroxide particles used herein are spherically shaped. The term “spherically shaped” or “spherical” is used herein to refer to an isometric shape, i.e., a shape, in which, generally speaking, the extension (particle size) is approximately the same in any direction. In particular, for a particle to be isometric, the ratio of the maximum and minimum length of chords intersecting the geometric center of the convex hull of the particle should not exceed the ratio of the least isometric regular polyhedron, i.e. the tetrahedron. Particle shapes are often times defined by aspect ratios, which is expressed by particle major diameter/particle thickness. In accordance with the present disclosure, the aspect ratio of the spherically shaped or spherical magnesium hydroxide particles ranges from about 1-2.

Particle size distribution D₅₀, also known as the median diameter or the medium value of the particle size distribution, is the value of the particle diameter at 50% in the cumulative distribution. For example, if D₅₀=10 µm, then 50 volume% of the particles in the sample have an averaged diameter larger than 10 µm, and 50 volume% of the particles have an averaged diameter smaller than 10 µm. Particle size distribution D₅₀ can be determined using light scattering methods following, for example, ASTM B822-10. In accordance with the present disclosure, the spherical magnesium hydroxide particles used herein have a particle size distribution D₅₀ ranging from about 20-100 µm, or about 25-60 µm, or about 30-50 µm. Moreover, the spherical magnesium hydroxide particles used herein may have an oil absorption value of about 1-30 ml/100 g, or about 3-20 ml/100 g, or about 3-8 ml/100 g. Furthermore, the spherical magnesium hydroxide particles used herein also may be surface treated with, for example, fatty acid, silane, zirconium based coupling agent, titanate coupling agent, carboxylates, etc.

In accordance with the present disclosure, the spherical magnesium particles may be present in the composition at a level of about 50-95 wt% or about 55-90 wt%, or about 60-85 wt%, based on the total weight of the TIM composition.

In addition to the spherical magnesium hydroxide particles, spherical aluminum oxide particles also may be added in the TIM composition. The spherical aluminum oxide particles used herein may have a particle size distribution D₅₀ ranging from about 5-100 µm, or about 10-80 µm, or about 20-60 µm. And the spherical aluminum oxide particles may be present in the TIM composition at a level of about 2-50 wt%, or about 2-40 wt%, or about 2-30 wt%, based on the total weight of the TIM composition.

Furthermore, the TIM compositions disclosed herein may optionally further comprise other thermally conductive particles, such as, aluminum hydroxide, magnesium oxide, boron nitride, etc. The TIM composition disclosed herein also may comprise other suitable additives, such as, catalysts, plasticizers, stabilizers, adhesion promoters, fillers, colorants, etc. Such optional additives may be present at a level of up to about 10 wt%, or up to about 8 wt%, or up to about 5 wt%, based on the total weight of the TIM.

As demonstrated below by the examples, by incorporating spherical magnesium hydroxide particles, TIM material with high thermal conductivity was obtained. Moreover, the further addition of spherical aluminum oxide particles further decreases the viscosity of the TIM material, which is a very much desirable feature for TIM material.

Further disclosed herein are battery pack systems in which a cooling unit or plate is coupled to a battery module (formed of one or more battery cells) via the TIM described above such that heat can be conducted therebetween. In one embodiment, the battery pack systems are those used in battery powered vehicles.

### EXAMPLES

Materials
Prepolymer — a prepolymer prepared by the reaction of polyoxypropylene diol, polyoxypropylene triol, and diphenylmethane-4,4'-diisocyanate;
PTSI — p-toluenesulfonyl isocyanate obtained from VanDeMark Chemicals;
HDI — hexamethylene diisocyanate (HDI) obtained from Covestro under the trade name N3400;
Plasticizer — polyester plasticizer obtained from Hallstar under the trade name Plasthall™ 190;
Silane — polyethyleneglycol-functional alkoxysilane obtained from Evonik under the trade name Dynasylan™ 4148;
Mg(OH)₂—S — spherical magnesium hydroxide particles obtained from Weifang Haolong Chemical CO.,LTD under the grade number HLG-05, which has a particle size distribution D₅₀ of 46 µm and oil absorption value of about 5 ml/100 g;
Mg(OH)₂—P — platelet magnesium hydroxide particles obtained from Liaoning Haichen Chemical CO,.LTD under the grade number HM-15, which has a particle size distribution D₅₀ of 3-4 µm and oil absorption value of about 37 ml/100 g;
Catalyst — 33% triethylenediamine dissolved in 67% dipropylene glycol, which is obtained from Evonik under the trade name Dabco™ 33-LV;
Al₂O₃ — spherically shaped aluminum oxide particle obtained from Anhui Estone under the grade name SLA45, which has a particle size distribution D₅₀ of 49 µm;
Polyol-1 — polyether polyol obtained from Dongda Chemical;
Polyol-2 — Polyether polyol obtained from Dow Chemicals under the trade name Voranol™ 4701.

Table 1

| | E1 | E2 | CE1 |
|---|---|---|---|
| Part A | | | |
| Prepolymer (wt%) | 11.5 | 11.3 | 11.5 |
| PTSI (wt%) | 1 | 1 | 1 |
| HDI (wt%) | 1 | 1.2 | 1 |
| Plasticizer (wt%) | 5.7 | 5.7 | 5.7 |
| Silane (wt%) | 0.8 | 0.8 | 0.8 |
| Mg(OH)₂—S (wt%) | 80 | 70 | |
| Al₂O₃ (wt%) | | 10 | |
| Mg(OH)₂—P (wt%) | | | 80 |
| Part B | | | |
| Silane (wt%) | 0.8 | 0.8 | 0.8 |
| Polyol-1 (wt%) | 8 | 8 | 8 |
| Polyol-2 (wt%) | 2 | 2 | 2 |
| Plasticizer (wt%) | 6.6 | 6.6 | 6.6 |
| Catalyst (wt%) | 0.1 | 0.1 | 0.1 |
| Mg(OH)₂—S (wt%) | 82.5 | 72.5 | |
| Al₂O₃ (wt%) | | 10 | |
| Mg(OH)₂—P (wt%) | | | 82.5 |
| Properties | | | |
| Thermal conductivity (W/mk) | 1.9 | 2.1 | N/A* |
| Viscosity (Part A), 10 S⁻¹ | 35.6 | 25.9 | |
| Viscosity (Part B), 10 S⁻¹ | 10.1 | 5.1 | |
| Lap shear strength (MPa) | 0.37 | 0.38 | |

*N/A: no homogenous dispersion was obtained.

### Examples E1-E2 and Comparative Example CE1

The components of the TIM composition in each of E1-E2 and CE1 are listed in Table 1. First, Part A and Part B for each sample were prepared as follows: mixing all components (liquid component(s) first before adding solid component(s)) using a dual asymmetric centrifuge; mixing the mixture for about 30 minutes under vacuum; and storing the mixture in two-component cartridges. Then, the viscosity for Part A and Part B in each of E1-E2 was measured at a shear rate of 10 S⁻¹ using AR1500EX Rheometer from TA Instruments and the results are tabulated in Table 1. For CE1, no homogenous dispersion was obtained for Part A or Part B.

To obtain the final TIM paste in E1 and E2, Part A and Part B were mixed at a weight ratio of 1:1 using a 2-component battery gun and a static mixer. The thermal conductivity of the TIM pastes was measured in accordance with ASTM D5470 at sample thickness of 1, 2, and 3 mm, and the Lap shear strength of the TIM pastes was measured in accordance with EN1465 at sample thickness of 1 mm. The results are tabulated in Table 1.

As demonstrated by the samples, by incorporating spherical magnesium hydroxide particles, homogenous TIM paste with high thermal conductivity was obtained. Moreover, the further addition of spherical aluminum oxide particles further decreases the viscosity of the TIM paste.

1. A thermal interface material (TIM) composition comprising:
a) a polymeric binder component, and
b) about 50-90 wt% of spherical magnesium hydroxide particles having a particle size distribution D50 ranging from about 20-100 µm,
with the total weight of the composition totaling to 100 wt%.

2. The thermal interface material composition of claim 1, wherein the spherical magnesium hydroxide particles have an oil absorption value of about 1-30 ml/100 g.

3. The thermal interface material composition of claim 1, wherein, the polymeric binder component is present at a level of about 10-50 wt%, based on the total weight of the composition.

4. The thermal interface material composition of claim 1, wherein, the polymeric binder component is formed of polyurethane based material.

5. The thermal interface material composition of claim 1, wherein, the spherical magnesium hydroxide particles have a particle size distribution D50 ranging from about 25-60 µm.

6. The thermal interface material composition of claim 1, wherein, the spherical magnesium hydroxide particles have a particle size distribution D50 ranging from about 30-50 µm.

7. The thermal interface material composition of claim 1, which further comprises about 2-50 wt% of spherical aluminum oxide particles.

8. The thermal interface material composition of claim 7, wherein the spherical aluminum oxide particles have a particle size distribution D50 ranging from about 5-100 µm.

9. An article comprising the thermal interface material composition recited in claim 1.

10. The article of claim 10, which further comprises a battery module that is formed of one or more battery cells and a cooling unit, wherein, the battery module is connected to the cooling unit via the thermal interface material composition.
